(19) United States
(12) Patent Application Publication
(10) Pub. No.: US 2026/0235741 A1
(43) Pub. Date: Aug. 13, 2026

(54) SYSTEM AND METHOD FOR CLEANING LiDAR LENS

(71) Applicant: ELECTRONICS AND TELECOMMUNICATIONS RESEARCH INSTITUTE, Daejeon (KR)

(72) Inventors: Ki Tae Kim, Daejeon (KR); JINWOO KIM, Daejeon (KR); MYUNGWOOK PARK, Daejeon (KR); KYOUNG HWAN AN, Daejeon (KR); MyungIn Ji, Daejeon (KR)

(21) Appl. No.: 19/460,584

(22) Filed: Jan. 27, 2026

(30) Foreign Application Priority Data
Feb. 11, 2025 (KR) 10-2025-0017391

(51) Int. Cl. G01S 7/497; G01S 7/481; G01S 17/931

(52) U.S. Cl. CPC G01S 7/497; G01S 7/4813; G01S 17/931; G01S 2007/4977

(57) ABSTRACT

A LiDAR cleaning system according to an embodiment disclosed herein may include a case having a transparent protective window and configured to protect a LiDAR sensor mounted therein, a cleaning device configured to clean the protective window, a communication module configured to obtain driving information of a vehicle, and a controller functionally connected to the LiDAR sensor, the cleaning device, and the communication module. The controller may determine whether the LiDAR sensor is obstructed due to contamination of the protective window using the LiDAR sensor, may determine whether a driving situation satisfies a safe operating condition of the cleaning device based on the driving information when obstruction of the LiDAR sensor is confirmed, and may remove contamination of the protective window through the cleaning device when the driving situation satisfies the operating condition.

### CROSS-REFERENCE TO RELATED APPLICATION

This application claims priority to and the benefit of Korean Patent Application No. 10-2025-0017391, filed on February 11, 2025, the disclosure of which is incorporated herein by reference in its entirety.

### BACKGROUND

### 1. Field of the Invention

Various embodiments disclosed herein relate to sensor-lens cleaning technology.

### 2. Description of Related Art

A vehicle may include sensors such as cameras and LiDAR (Light Detection and Ranging) for advanced driver-assistance functions and autonomous-driving functions, and the vehicle may recognize surrounding objects through the sensors.

An autonomous vehicle may continuously perceive a real-time environment while driving using the sensors, and may perform driving stability control, path planning, and obstacle avoidance based on the perception result. Thus, operation and performance of the sensors are closely related to safe and efficient autonomous driving of the autonomous vehicle.

However, because a LiDAR sensor has optical characteristics, adhesion of foreign contaminations may obstruct the field of view (reduce visibility), and thus degrade transmission and reception sensitivity. As a result, perception performance may be degraded. Furthermore, the LiDAR sensor of a vehicle may be exposed to external factors such as rain, snow, and dust, and therefore may fail to accurately perceive the surrounding environment due to a blurred field of view.

To prevent this, an autonomous vehicle may include a LiDAR cleaning system, and may remove foreign contaminations from the LiDAR sensor through the LiDAR cleaning system to ensure sensor performance.

### SUMMARY OF THE INVENTION

A LiDAR cleaning system may use a direct injection of a cleaning liquid to prevent contamination caused by external substances. Although such a method may be useful for removing basic contamination, it may fail to protect the sensor in certain circumstances, and the cleaning process may negatively affect sensor performance. For example, when the cleaning liquid is directly injected onto the sensor surface, residual cleaning liquid may remain on the sensor surface and may decrease measurement accuracy, and repetitive cleaning operations may cause damage or wear to the sensor surface. In another example, a water-injecting method may have limitations in quickly removing foreign contaminations that accumulate on the sensor surface during high-speed driving, and may negatively affect durability of the sensor.

Various embodiments disclosed herein may provide a LiDAR cleaning system and method that may remove contamination of the LiDAR-sensor lens in a manner responsive to driving conditions of a vehicle.

According to an embodiment disclosed herein, a LiDAR cleaning system may include: a case including a transparent protective window and configured to protect a LiDAR sensor mounted therein; a cleaning device configured to clean the protective window; a communication module configured to obtain driving information of a vehicle; and a controller functionally connected to the LiDAR sensor, the cleaning device, and the communication module, wherein the controller is configured to: determine whether the LiDAR sensor is obstructed due to contamination of the protective window using the LiDAR sensor; when obstruction of the LiDAR sensor is confirmed, determine whether a driving situation satisfies a safe operating condition of the cleaning device based on the driving information; and when the driving situation satisfies the operating condition, remove contamination of the protective window through the cleaning device.

In an embodiment disclosed herein, a method for cleaning a LiDAR sensor mounted in a case having a transparent protective window, the method comprising: determining, using the LiDAR sensor, whether the LiDAR sensor is obstructed due to contamination of the protective window; when obstruction of the LiDAR sensor is confirmed, determining whether a driving situation satisfies a safe operating condition of a cleaning device based on driving information of a vehicle; and when the driving situation satisfies the operating condition, removing contamination of the protective window through the cleaning device.

In an embodiment disclosed herein, a LiDAR cleaning system may include: a transparent protective window disposed to cover a LiDAR sensor so as to maintain a field of view of the LiDAR sensor; a foldable wiper configured to selectively contact or be spaced apart from the protective window; a first motor configured to move the wiper; a second motor configured to rotate the protective window; and a controller, wherein the controller is configured to: control the first motor to bring the wiper into contact with the protective window, and control the second motor to rotate the protective window while the wiper contacts the protective window to remove contamination from the protective window; or control the first motor to space the wiper apart from the protective window, and control the second motor to rotate the protective window while the wiper is spaced apart from the protective window.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating an appearance of a LiDAR cleaning system according to an embodiment.

FIG. 2 is a block diagram illustrating a configuration of a LiDAR cleaning system according to an embodiment.

FIGS. 3A, 3B, and 3C illustrate a configuration of a cleaning device according to an embodiment.

FIG. 4 illustrates a wiper according to an embodiment.

FIG. 5 illustrates another embodiment of wiper movement.

FIG. 6 is a bottom perspective view of a cleaning device according to an embodiment.

FIG. 7 is a flowchart illustrating a LiDAR cleaning method according to an embodiment.

FIG. 8 is a detailed flowchart illustrating a LiDAR cleaning method according to an embodiment.

In the description of the drawings, identical or similar reference numerals may be used for identical or similar components.

### DETAILED DESCRIPTION OF THE EMBODIMENTS

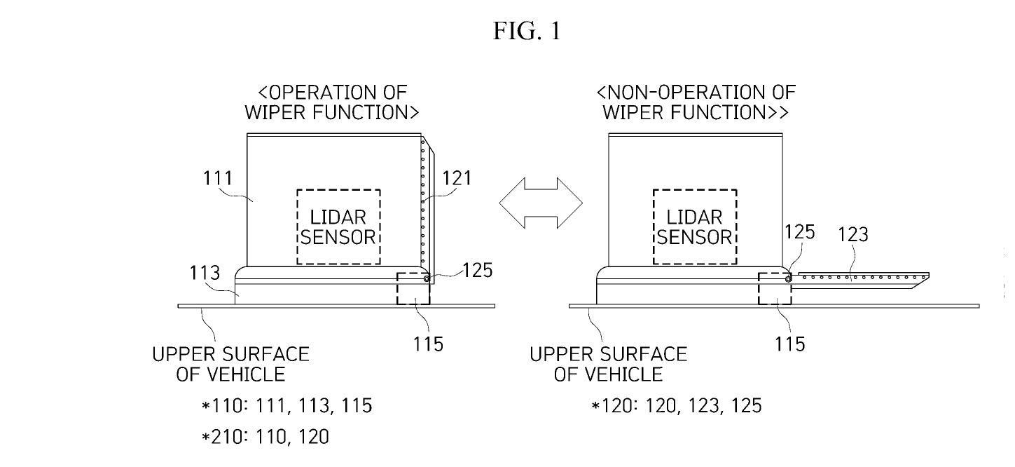

FIG. 1 illustrates an appearance of a LiDAR cleaning system according to an embodiment.

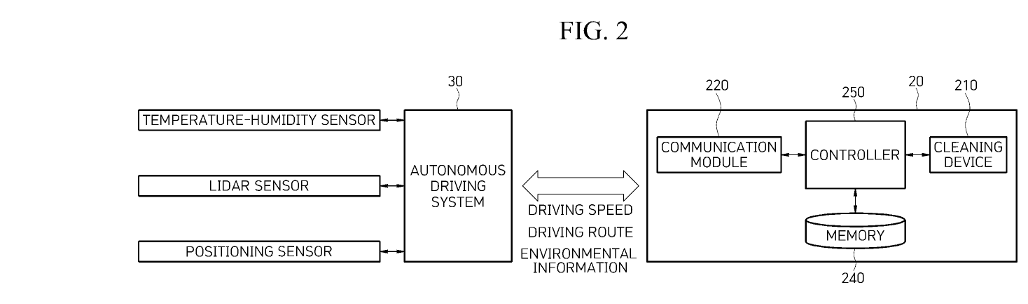

Referring to FIG. 1, a LiDAR cleaning system (20) may include a case (110), a cleaning device (210), and a controller (i.e., a controller (250) of FIG. 2).

In an embodiment, the case (110) may protect a LiDAR sensor mounted therein from external physical impacts or environmental factors such as dust, snow, or raindrops. The case (110) may be made of a highly durable material and may be configured to ensure external visibility of the LiDAR sensor. The case (110) may include a transparent protective window (111) and a lower member (113).

The protective window (111) may be configured so that its upper surface and side surface are made of a transparent material to ensure external visibility of the LiDAR sensor. The protective window (111) may be formed in a cylindrical shape and, in a state coupled to the lower member (113), may rotate clockwise or counterclockwise when viewed from the top of the case (110)

The lower member (113) may be fixed to an upper surface of a vehicle and may secure the protective window (111) mounted thereon so as to ensure rotation of the protective window (111). For example, when the lower member (113) is coupled to the protective window (111), the lower member (113) may be fixed to ensure rotation of the protective window (111) A fitting groove (115) that is coupled to the cleaning device (210) may be formed at one side of the lower member (113).

In an embodiment, the cleaning device (210) may include a foldable wiper (120), an injector, and a heater. The foldable wiper (120) may be fixed to the case (110) through a coupling region (125) and, in a state of being in contact with the protective window (111), may remove contamination of the protective window (111). The injector and the heater will be described in detail below.

The wiper (120) may include a wiper arm (123), a silicone blade (121) provided at one side of the wiper arm (123), and a nozzle (127) provided at a side surface of the wiper arm (123) to inject a cleaning liquid. The wiper arm (123) may be contacted with or separated from the protective window (111) under control of the controller (250). The nozzle (127) may inject the cleaning liquid from the injector under control of the controller (250).

When the protective window (111) rotates while the silicone blade (121) is in contact with the protective window (111) (hereinafter, referred to as "during wiper-function operation"), contamination accumulated on a surface of the protective window (111) may be removed by the silicone blade (121). The silicone blade (121) may be made of a silicone material similar to a blade of a vehicle wiper. The wiper (120) may be separated from the protective window (111) when the wiper function is not operated and may be positioned adjacent to an upper surface of the vehicle.

In an embodiment, the controller (250) may operate the cleaning device (210) to clean the protective window (111) that ensures visibility of the LiDAR sensor. The controller (250) may perform various cleaning functions according to driving information of the vehicle.

According to one embodiment, the controller (250) may determine contamination of the protective window (111) that limits visibility of the LiDAR sensor based on detection information of the LiDAR sensor (e.g., an image). When contamination of the protective window (111) is confirmed, the controller (250) may determine, based on driving information (e.g., a driving speed, a driving route, or environmental conditions), whether a safe operating condition of the wiper (120) is satisfied. The operating condition may be, for example, that a driving speed is lower than a threshold speed (e.g., a low-speed state or a stationary state).

According to one embodiment, when the controller (250) confirms that a vehicle situation satisfies an operating condition, the controller (250) may operate a wiper function. For example, the controller (250) may remove contamination of the protective window (111) by rotating the protective window (111) while the silicone blade (121) of the wiper (120) is in contact with the protective window (111). In detail, during wiper operation (i.e., when cleaning contamination of the protective window (111)), the controller (250) may apply a control signal to a first driving unit associated with movement of the wiper (120) and may move the wiper arm (123) toward an upper side of the cleaning device (210) so that the silicone blade (121) is brought into contact with the protective window (111). The controller (250) may apply a control signal to a second driving unit associated with rotation of the protective window (111) and may rotate the protective window (111). Additionally, when the controller (250) confirms that contamination of the LiDAR sensor has been removed or that a vehicle situation does not satisfy the operating condition during wiper-function operation, the controller (250) may stop the wiper function and may return the wiper (120) to a storage position through the first driving unit. The controller (250), for example, may return the wiper arm (123) to a storage position in which the wiper arm (123) is horizontal to an upper surface of the vehicle so that the wiper (120) is spaced apart from the protective window (111).

According to one embodiment, when a vehicle situation does not satisfy an operating condition, the controller (250) may determine not to operate the wiper. The controller (250) may determine a driving direction based on driving information and may slightly rotate the protective window (111) such that a contaminated region of the protective window (111) is moved out of the driving direction (or such that a clean portion of the protective window (111) is positioned in the driving direction). For example, when a driving speed is equal to or greater than a threshold speed (i.e., during high-speed driving of the vehicle), the controller (250) may position the contaminated region at a rear side of the vehicle by rotating the protective window (111) without deploying the wiper (120). In this manner, in an embodiment, when the wiper function is not operated, the wiper (120) may be spaced apart from the protective window (111) so that the wiper (120) does not obstruct a field of view of the LiDAR sensor. As described above, a LiDAR cleaning system (20) according to an embodiment may operate the cleaning device (210) in a situation in which operation of the wiper (120) is safe while considering driving conditions such as a weather condition, a driving speed, or a driving route. For example, the LiDAR cleaning system (20) may refrain from cleaning the protective window (111) using the wiper (120) during high-speed driving, and may clean contamination of the protective window (111) using the wiper (120) during a congested section or during low-speed driving.

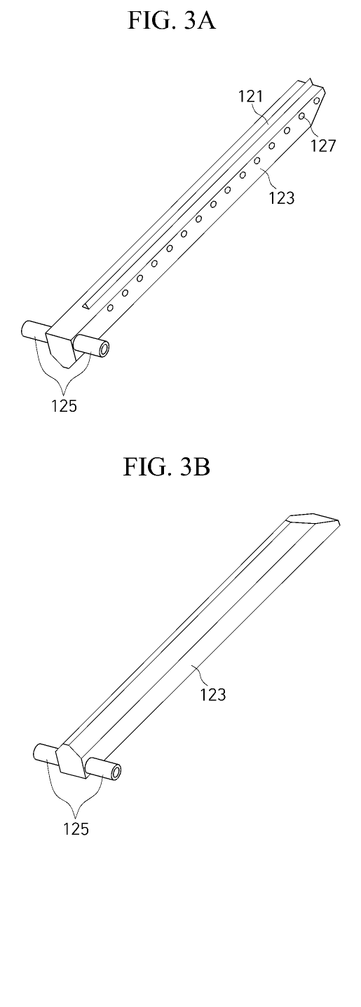

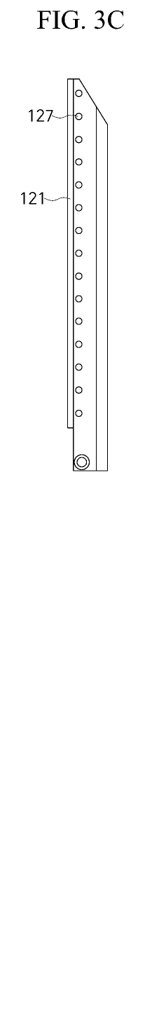

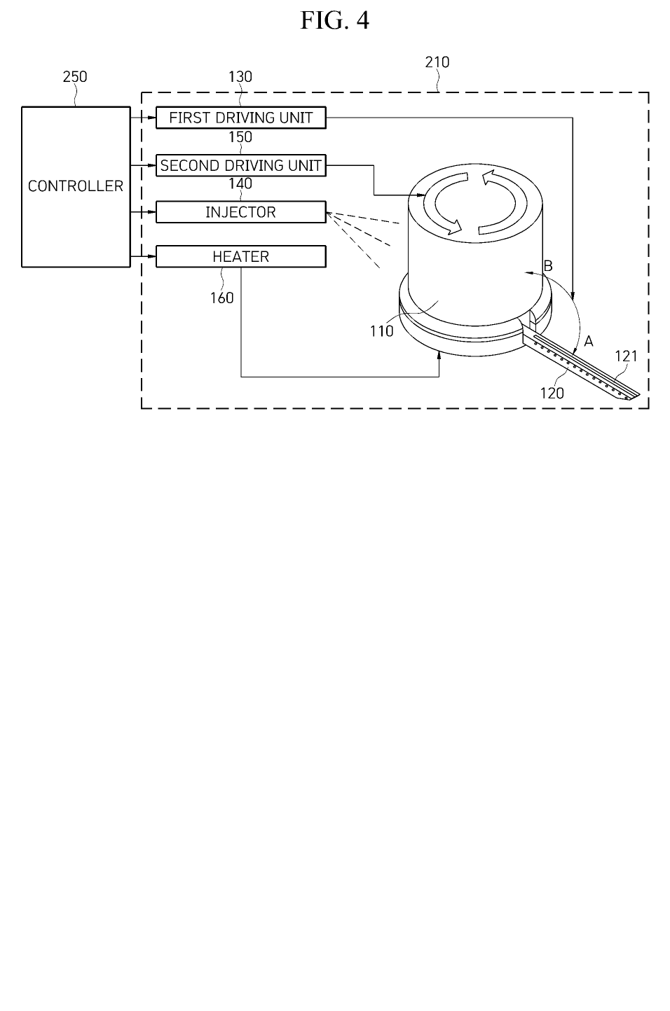

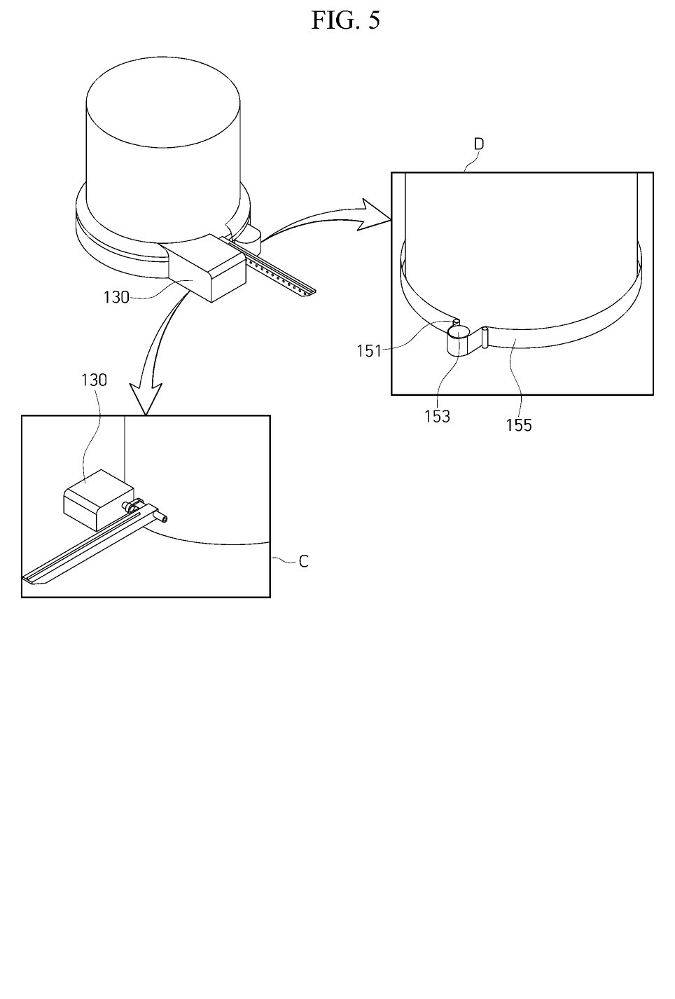

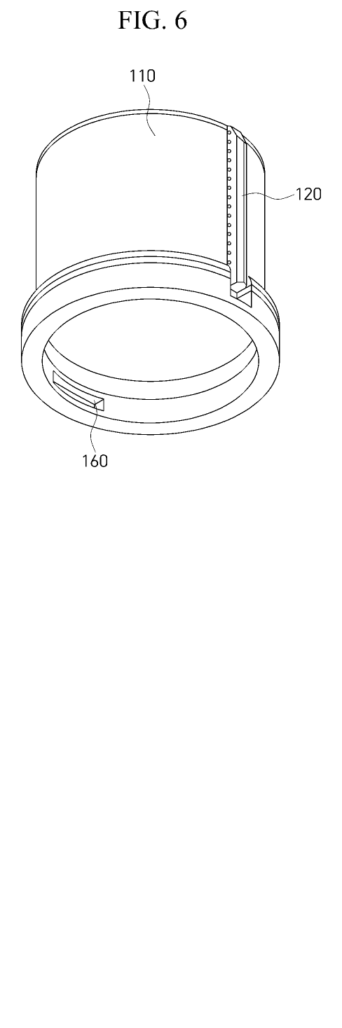

FIG. 2 illustrates a configuration of a LiDAR cleaning system according to an embodiment, FIGS. 3A, 3B, and 3C illustrate a wiper according to an embodiment, and FIG. 4 illustrates a configuration of a cleaning device according to an embodiment. FIG. 5 is a view illustrating a coupling relationship among the wiper and first and second driving units according to an embodiment, and FIG. 6 is a bottom perspective view of a cleaning device according to an embodiment.

Referring to FIG. 2, a LiDAR cleaning system (20) according to an embodiment may include a cleaning device (210), a communication module (220), a memory (240), and a controller (250). In an embodiment, the LiDAR cleaning system (20) may omit some components or may further include additional components. For example, the LiDAR cleaning system (20) may include a temperature-humidity sensor configured to detect an external temperature and humidity of a vehicle. In addition, some components of the LiDAR cleaning system (20) may be combined into a single entity while performing the same functions as the components before being combined. At least a portion of the LiDAR cleaning system (20) (e.g., at least a portion of the controller (250)) may be included in an autonomous driving system.

Referring to FIG. 4, the cleaning device (210) may include the wiper (120), a first driving unit (130), a second driving unit (150), an injector (140), and a heater (160).

Referring to FIGS. 3A, 3B, and 3C, the wiper (120) may include the nozzle (127), the wiper arm (123), and the silicone blade (121). The wiper arm (123) may have an elongated shape, and the silicone blade (121) may be formed (or provided) at one side of the wiper arm (123), and one end of the wiper arm (123) may include a coupling region (125). FIG. 3A is a perspective view of the wiper in which the silicone blade (121) faces an upper side of the cleaning device (210), FIG. 3B is a perspective view of the wiper in which the silicone blade (121) faces a lower side of the cleaning device (210), and FIG. 3C is a view of the wiper in which the silicone blade (121) faces a left side. In FIGS. 3A to 3C, the coupling region (125) is illustrated as extending left and right from the wiper arm (123) as an example. However, the disclosure is not limited thereto.

When the coupling region (125) is fitted into a plurality of holes formed in the groove (115) on the lower member (113) of the case (110) (or into holes in which the first driving unit (150) of FIG. 5 is embedded), the wiper (120) is coupled to the lower member (113). In a state in which the coupling region (125) is fitted into the plurality of holes, the wiper arm (123) may move upward toward an upper side of the cleaning device (210) or downward (or toward an outer lateral side) according to movement of the first driving unit (130). When one end of the wiper arm (123) faces an upper direction of the cleaning device (210) (hereinafter, referred to as a “first direction”), the silicone blade (121) contacts the protective window (111). When the wiper arm (123) faces an outer lateral direction of the cleaning device (210) (hereinafter, referred to as a “second direction”), the silicone blade (121) may be positioned close to (or in contact with) an upper surface of the vehicle and may be spaced apart from the protective window (111).

The first driving unit (130) may be coupled to one end of the wiper (120) and may move the wiper (120) such that another end of the wiper (120) faces an outer lateral direction of the cleaning device (210) (i.e., the direction A of FIG. 4), or may move the wiper (120) such that the other end faces an upper direction of the cleaning device (210) (i.e., the direction B of FIG. 4).

As shown in the enlarged view C of FIG. 5, which illustrates another viewing direction (rotated approximately 45 degrees counterclockwise), the first driving unit (130) may be embedded in the lower member (113) and may include a motor that applies a first force or a second force. The first force is that lift the wiper (120) toward an upper direction of the cleaning device (210) through one end of the wiper (120). The second force is that lower the wiper (120) toward a lower direction of the cleaning device (210) (see the direction B of FIG. 4). The first driving unit (130) may further include an additional member (e.g., a hinge or a spring member) configured to transmit a lifting force to the wiper arm (123)

Control of movement of the wiper arm (123) by the first driving unit (130) may be readily derived by a person skilled in the art based on robotic control technologies or vehicle wiper control technologies s, and thus, a detailed description thereof will be omitted.

As shown in FIG. 5, the second driving unit (150) may rotate the protective window (111), which is coupled to an upper portion of the lower member (113), clockwise or counterclockwise when viewed downward from an upper side of the cleaning device (210) under control of the controller (250).

Referring to the enlarged view D of FIG. 5, the second driving unit (150) may include a pulley tensioner (151), a motor (153), and a belt (155). The pulley tensioner (151) may adjust tension between the motor (153) and the belt (155), and the motor (153) may rotate the protective window (111) by rotating while being in contact with the protective window (111). In various embodiments, the lower member (113) may include a first region that is coupled to the protective window (111) and a second region that is provided outside the first region and fixes the wiper (120) through the first driving unit (130). In this case, the second driving unit (150) may rotate the protective window (111) by rotating the first region while keeping the second region fixed. Rotation of the protective window (111) by the second driving unit (150) may be derived by a person skilled in the art based on mechanical algorithms, and therefore a detailed description thereof will be omitted.

The injector (140) may inject a cleaning liquid onto an outer surface of the protective window (111) through the nozzle (127) of the wiper (120) under control of the controller (250). An amount of the cleaning liquid injected by the injector (140) may be adjusted under control of the controller (250). The nozzle (127) may be provided to inject the cleaning liquid toward the protective window (111).

Referring to FIG. 6, the heater (160) may be provided at a portion of the case (110) and may heat the case (110) under control of the controller (250). Heat generated by the heater (160) may prevent icing of the protective window (111), thereby preventing obstruction of the LiDAR sensor caused by icing.

The communication module (220) may support establishment of a communication channel or a wireless communication channel between the LiDAR cleaning system (20) and another device (e.g., an autonomous driving system), and may support communication through the established communication channel. The communication channel may include at least one channel among a controller area network (CAN), Ethernet, or Serial communication.

The memory (240) may include various types of volatile or non-volatile memory. For example, the memory (240) may include a read only memory (ROM) and a random access memory (RAM). In an embodiment, the memory (240) may be located inside or outside the controller (250), and the memory (240) may be connected to the controller (250) through various known means. The memory (240) may store various data used by at least one component of the LiDAR cleaning system (20) (e.g., the controller (250)). The data may include, for example, input data or output data for software and related instructions. For example, the memory (240) may store at least one instruction and data for cleaning a LiDAR sensor.

The controller (250) may control at least one other component of the LiDAR cleaning system (20) (e.g., a hardware or software component) and may perform various data processing or operations. The controller (250) may include, for example, at least one of a central processing unit (CPU), a graphics processing unit (GPU), a microprocessor, an application processor, an application-specific integrated circuit (ASIC), or a field programmable gate array (FPGA), and may include multiple cores.

In an embodiment, the controller (250) may communicate with an autonomous driving system through the communication module (220).

According to one embodiment, the autonomous driving system may determine whether the LiDAR sensor is obstructed based on detection information of the LiDAR sensor (e.g., an image). When the autonomous driving system confirms obstruction of the LiDAR sensor, the autonomous driving system may transmit obstruction-state information to the LiDAR cleaning system (20) through a vehicle network, and the controller (250) may receive the obstruction-state information through the communication module (220). The obstruction-state information may include, for example, information related to a blocked region (or a contaminated region) and a degree of contamination.

According to one embodiment, the controller (250) may receive driving information of the vehicle (e.g., a driving speed, a driving route, or environmental information) from the autonomous driving system through the communication module (220).

In this regard, the autonomous driving system may transmit a driving speed, a driving route (e.g., a lane-change signal), and environmental information (e.g., temperature and humidity information outside the vehicle detected by a sensor, or weather information by location) to the LiDAR cleaning system (20) through a vehicle network. For example, when the driving speed is equal to or lower than a threshold speed, the autonomous driving system may transmit vehicle-stop information. In another example, when the vehicle is in a lane-change situation, the autonomous driving system may transmit lane-change information. In yet another example, the autonomous driving system may transmit weather information by driving location based on positioning information and weather information. Additionally, the autonomous driving system may communicate temperature-humidity information detected by a temperature-humidity sensor. Accordingly, the LiDAR cleaning system (20) may acquire at least one of vehicle-stop information, lane-change information, weather information by location, or temperature- humidity information through the communication module (220).

In an embodiment, the controller (250) may determine whether the LiDAR sensor is obstructed due to contamination of the protective window (111) using the LiDAR sensor. For example, when the controller (250) receives obstruction-state information from the autonomous driving system through the communication module (220), the controller (250) may determine that the LiDAR sensor is in an obstructed state.

In an embodiment, when the LiDAR sensor is in an obstructed state, the controller (250) may adjust at least one of whether to operate the cleaning device (210), an operating mode, an operating intensity, or an operating cycle based on the driving information.

According to one embodiment, the controller (250) may determine, based on driving information, whether a driving situation of the vehicle satisfies a safe operating condition (a specified operating condition) of the cleaning device (210). For example, when the controller (250) receives vehicle-stop information (or lane-change information), the controller (250) may determine that the driving situation satisfies the operating condition. In another example, when the controller (250) receives lane-change information, the controller (250) may determine that the operating condition is satisfied.

According to one embodiment, when the driving situation satisfies the operating condition, the controller (250) may determine to operate a wiper function. To operate the wiper function, the controller (250) may control the first driving unit (130) to bring the silicone blade (121) into contact with the protective window (111) and may control the second driving unit (150) to rotate the protective window (111). Then, the silicone blade (121), which is in contact with the protective window (111), may remove contamination from the protective window (111).

When the vehicle is driving at a low speed in an urban area (less than 30 km/h) or is in a stopped state, the controller (250) may receive vehicle-stop information from the autonomous driving system. In this case, when the controller (250) receives obstruction-state information of the LiDAR sensor from the autonomous driving system, the controller (250) may precisely clean the protective window (111). For example, the controller (250) may inject a cleaning liquid (or water) onto the protective window (111) through the injector (140), may bring the silicone blade (121) of the wiper (120) into contact with the protective window (111) through the first driving unit (130). And then, the controller (250) may rotate the protective window (111) through the second driving unit (150), thereby removing contamination attached to the protective window (111).

Additionally, according to one embodiment, the controller (250) may remove contamination so that detection of the LiDAR sensor is not hindered depending on surrounding obstacle conditions. For example, the controller (250) may interact with an autonomous driving system to determine surrounding obstacle conditions and may control a rotational speed of the protective window (111) and an amount of cleaning liquid injected so as not to obstruct visibility (or field of view) of the LiDAR sensor for autonomous driving. The autonomous driving system may also transmit obstacle-region information related to obstacle positions to the LiDAR cleaning system (20). In this case, the controller (250) may control rotation of the protective window (111) and injecting of the cleaning liquid such that the contaminated region does not block visibility (or field of view) toward an obstacle position based on the obstacle-region information.

According to one embodiment, when a driving situation does not satisfy an operating condition, the controller (250) may determine not to operate a wiper function. In this case, the controller (250) may determine a driving direction based on driving information, may place the wiper (120) at a storage position spaced apart from the protective window (111), and may rotate the protective window (111) such that a contaminated region moves out of the driving direction. For example, when the vehicle is driving at a high speed — such as driving at 100 km/h on a highway — ensuring a forward field of view is extremely important. However, contaminants such as insects, dust, mud, or raindrops attached to the protective window (111) may significantly obstruct the forward field of view. Moreover, during high-speed driving, operating the wiper function may hinder visibility of the LiDAR sensor, or new foreign contaminations may attach after wiper operation, rendering the wiping ineffective. Alternatively, during high-speed driving, foreign contaminations attached to a surface of the protective window (111) may be removed by airflow generated during driving. Accordingly, the controller (250) may refrain from operating the wiper function and may rotate the protective window (111) so that the contaminated region moves to a position other than the forward direction of the vehicle. For example, when a foreign contamination is attached to the left side of the vehicle, the controller (250) may rotate the protective window (111) toward a left direction of the vehicle. When a foreign contamination is attached to the right side of the vehicle, the controller (250) may rotate the protective window (111) toward a right direction of the vehicle. As a result, the foreign contamination may be removed from the surface of the protective window (111) due to rotation of the protective window (111) and airflow during driving. Even if the foreign contamination is not removed, it may move out of the field of view of the LiDAR sensor in the driving direction.

In an embodiment, the controller (250) may automatically adjust an optimal cleaning frequency and intensity according to a driving speed, a driving route, and environmental conditions of the vehicle. For example, when the vehicle is driving at high speed on a highway, the controller (250) may detect dust, water droplets, or other contaminants that may accumulate on a surface of the LiDAR sensor, may maintain the wiper (120) in a state spaced apart from the protective window (111), and may operate rotation of the protective window (111). Additionally, the controller (250) may inject a cleaning liquid depending on a degree of contamination. In this case, airflow generated during driving may be added to rotational force of the protective window (111), and foreign contaminations attached to the protective window (111) may be removed quickly, thereby enabling rapid restoration of the field of view of the LiDAR sensor. In another example, when the vehicle is in a congested area or is in a stopped state, the controller (250) may bring the wiper (120) into contact with the protective window (111) and may delicately clean the LiDAR sensor by adjusting a rotational speed, a rotational direction, and an amount of cleaning liquid injected according to surrounding obstacle conditions, so that visibility (of field of view ) of the LiDAR sensor is not limited.

In an embodiment, the controller (250) may adjust a cleaning cycle and a cleaning intensity of the protective window (111) through the cleaning device (210) based on at least one environmental condition among weather information by driving location or detected temperature-humidity information. For example, when the controller (250) confirms, based on at least one environmental condition, that a degree of contamination of the protective window (111) is higher than a threshold, the controller (250) may remove contamination of the protective window (111) through the cleaning device (210) regardless of whether an operating condition is satisfied. The threshold may be a degree of contamination to which the LiDAR sensor cannot perceive due to contamination. For instance, the controller (250) may differently control a rotational speed of the protective window (111) according to an amount of snow or rain based on at least one environmental condition. Additionally, the controller (250) may control whether to inject a cleaning liquid or may adjust an amount of the cleaning liquid depending on a degree of contamination of the protective window (111).

In an embodiment, when the controller (250) predicts icing of the protective window (111) based on at least one environmental condition, the controller (250) may prevent surface icing of the protective window (111) by operating the heater (160). For example, when the controller (250) confirms from temperature-humidity information that the temperature is lower than a threshold temperature, or confirms based on weather information by location that snow is expected, the controller (250) may operate the heater (160) to heat the protective window (111).In another example, when the vehicle is driving in a region with heavy snowfall, the controller (250) may detect, based on weather information by location and detected temperature-humidity information, that an ambient temperature is lower than a threshold temperature (e.g., 0°C) and that snow or high humidity is present. Then, the controller (250) may operate the heater (160) to supply heat to the protective window (111) so as to warm the protective window (111). Accordingly, in an embodiment, the controller (250) may maintain a constant temperature of the protective window (111), thereby preventing snow, ice, or frost from accumulating on a surface of the LiDAR sensor and obstructing its visibility.

In various embodiments, when contamination of the protective window (111) is not removed even after cleaning the wiper (120) by a non-wiper cleaning method (i.e., rotation of the protective window (111)) because a driving situation does not satisfy a safe operating condition of the wiper (120), the controller (250) may clean the protective window (111) by injecting a cleaning liquid or by operating the wiper (120) to ensure safety of autonomous driving.

As described above, according to an embodiment, the LiDAR cleaning system (20) may effectively clean foreign contaminations that obstruct a field of view of the LiDAR sensor and interfere with an autonomous-driving function according to driving conditions such as weather conditions, a driving speed of the vehicle, or a driving route, and according to surrounding obstacle conditions.

In an embodiment, the LiDAR cleaning system (20) may determine at least one of whether to inject a cleaning liquid onto the protective window of the LiDAR sensor, an amount of the cleaning liquid to be injected, whether to operate the wiper, or whether to rotate the protective window according to an external environment or a driving situation, and may appropriately clean contamination of the LiDAR sensor in various situations.

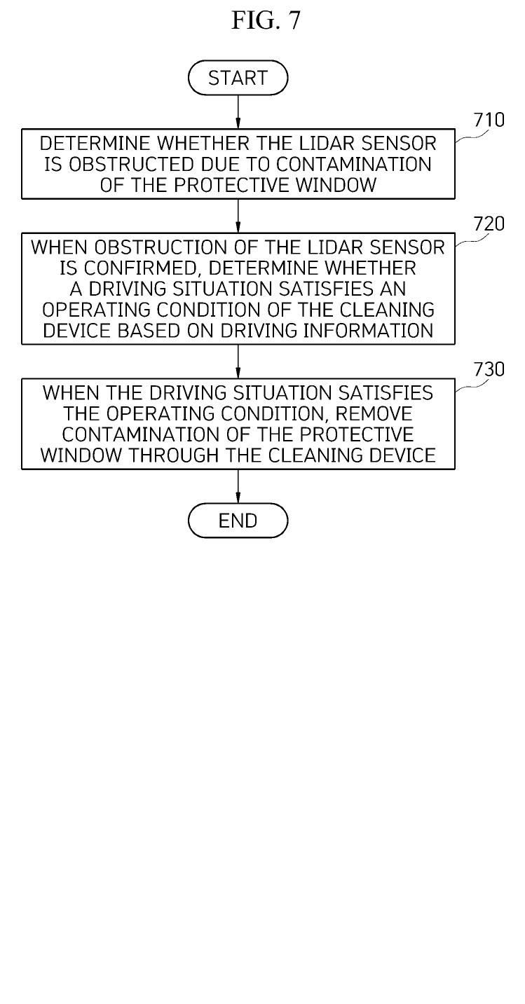

FIG. 7 is a flowchart illustrating a LiDAR cleaning method according to an embodiment.

Referring to FIG. 7, in operation 710, the LiDAR cleaning system (20) may determine whether the LiDAR sensor is obstructed due to contamination of the protective window (111) by using the LiDAR sensor. For example, the LiDAR sensor may transmit detection data to an autonomous driving system, and when the autonomous driving system detects obstruction of the LiDAR sensor based on the detection data, the autonomous driving system may transmit obstruction-state information to the LiDAR cleaning system (20).

In operation 720, when the LiDAR cleaning system (20) confirms obstruction of the LiDAR sensor, the LiDAR cleaning system (20) may determine, based on driving information of the vehicle, whether a driving situation satisfies a safe operating condition of the cleaning device (210). For example, the LiDAR cleaning system (20) may determine that the operating condition of the cleaning device (210) is satisfied when a driving speed is lower than a threshold speed or when lane-change information is confirmed.

In operation 730, when the driving situation satisfies the operating condition, the LiDAR cleaning system (20) may remove contamination of the protective window (111) through the cleaning device (210).

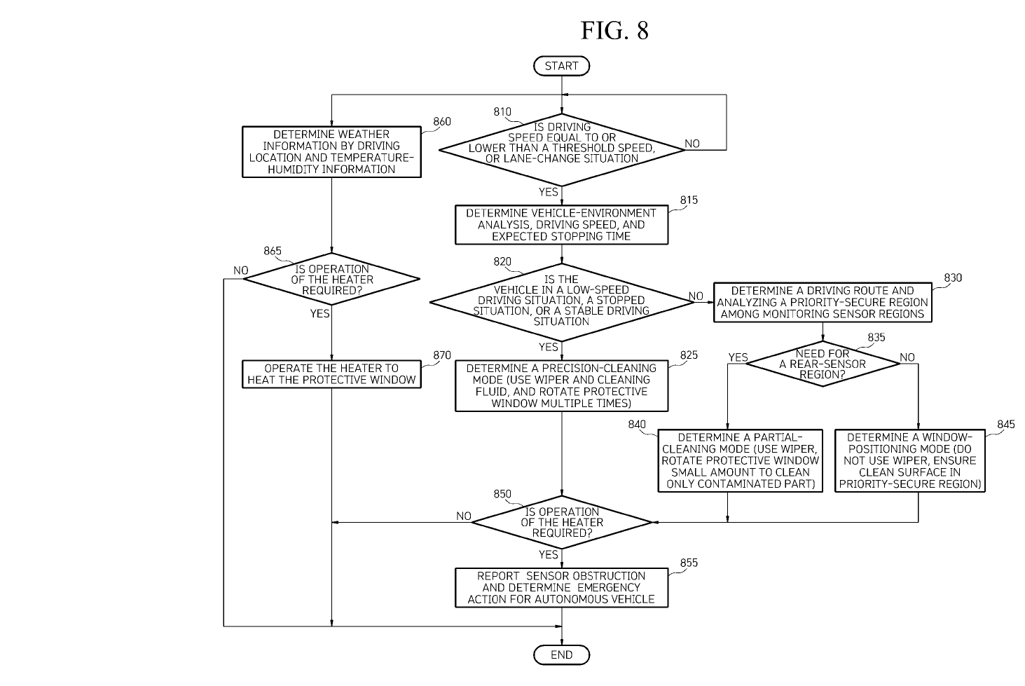

FIG. 8 is a detailed flowchart illustrating a LiDAR cleaning method according to an embodiment.

Referring to FIG. 8, in operation 810, the LiDAR cleaning system (20) may determine whether visibility (field of view) of the LiDAR sensor is obstructed based on detection data of the LiDAR sensor. For example, the LiDAR cleaning system (20) may determine whether a region of an autonomous-driving monitoring sensor is obstructed based on obstruction-state information received from an autonomous driving system, which confirms obstruction of the autonomous-driving monitoring sensor region based on the detection data.

In operation 815, the LiDAR cleaning system (20) may determine a vehicle-environment analysis, a driving speed, and an expected stopping time. For example, the LiDAR cleaning system (20) may analyze a vehicle environment based on driving information (and detection information) received through a vehicle network, and may obtain the driving speed, lane-change information, and expected stopping time of the vehicle.

In operation 820, the LiDAR cleaning system (20) may determine whether the vehicle is in a low-speed driving situation, in a stopped situation (i.e., when the driving speed is equal to or less than a threshold speed), or in a stable driving situation.

In operation 825, when the LiDAR cleaning system (20) confirms that the vehicle is in a low-speed driving situation, in a stopped situation (i.e., when the driving speed is equal to or less than a threshold speed (e.g., 1km/h)), or in a stable driving situation, the LiDAR cleaning system (20) may determine a precision-cleaning mode in operation 825. For example, in the precision-cleaning mode, the LiDAR cleaning system (20) may bring the silicone blade (121) of the wiper (120) into contact with the protective window (111) by using the first driving unit (130), may inject a cleaning liquid, and may rotate the protective window (111) by a large amount (or multiple times) by using the second driving unit (150), thereby precisely removing contamination of the protective window (111) through the wiper (120).

If, in operation 820, it is determined that the vehicle is not in a low-speed driving situation, a stopped situation, or a stable driving situation, the LiDAR cleaning system (20) may determine a driving route in operation 830 and may analyze a priority-secure region among monitoring-sensor regions based on the confirmed driving route. For example, when a driving direction is a left direction, the LiDAR cleaning system (20) may analyze a left region as the priority-secure region.

In operation 835, the LiDAR cleaning system (20) may determine, based on the analysis result of the priority-secure region, whether a rear-sensor region is required.

When the LiDAR cleaning system (20) confirms in operation 835 that a rear-sensor region is required, the LiDAR cleaning system (20) may determine a partial-cleaning mode in operation 840. In the partial-cleaning mode, the LiDAR cleaning system (20) may deploy the wiper (120) and may rotate the protective window (111) by a small amount (i.e., a few times) to clean only a contaminated portion.

In contrast, when the LiDAR cleaning system (20) confirms in operation 835 that a rear-sensor region is not required, the LiDAR cleaning system (20) may determine a window-positioning mode in operation 845. In this case, the LiDAR cleaning system (20) may rotate the protective window (111) such that a clean surface of the protective window (111) is positioned in the priority-secure region without deploying the wiper (120).

In operation 850, the LiDAR cleaning system (20) may determine whether obstruction of an autonomous-driving monitoring-sensor region is improved through a precision-cleaning mode, a partial-cleaning mode, or a window-positioning mode. For example, the LiDAR cleaning system (20) may determine whether contamination of the protective window (111) has been removed based on obstruction-state information received from an autonomous driving system.

When the LiDAR cleaning system (20) confirms in operation 850 that obstruction of the autonomous-driving monitoring-sensor region has been improved, the LiDAR cleaning system (20) may stop rotation of the protective window (111) in each mode and may return the deployed wiper (120) to a storage position.

In contrast, when the LiDAR cleaning system (20) confirms in operation 850 that obstruction of the autonomous-driving monitoring-sensor region has not been improved, the LiDAR cleaning system (20) may report obstruction of the sensor region to the autonomous driving system and may determine (or request) an emergency action of the autonomous-driving vehicle in operation 855.

In operation 860, the LiDAR cleaning system (20) may determine weather information by driving location and detected temperature/humidity information.

In operation 865, the LiDAR cleaning system (20) may determine whether operation of the heater (160) is required based on detected temperature/humidity information or weather information. The LiDAR cleaning system (20) may periodically determine whether operation of the heater (160) is required during use of the LiDAR sensor, including in an autonomous-driving mode.

When the LiDAR cleaning system (20) confirms in operation 865 that operation of the heater is required for the LiDAR sensor, the LiDAR cleaning system (20) may operate the heater (160) in operation 870 to heat the protective window (111) and may prevent or improve obstruction of visibility caused by condensation on the protective window (111).

As described above, in an embodiment, the LiDAR cleaning system (20) may effectively clean foreign contaminations that obstruct a field of view of the LiDAR sensor and interfere with an autonomous-driving function according to driving conditions (e.g., weather conditions, driving speed of the vehicle, or driving route) and surrounding obstacle conditions.

In an embodiment, the LiDAR cleaning system (20) may determine at least one of whether to inject a cleaning liquid onto a protective window of the LiDAR sensor, an amount of the cleaning liquid to be injected, whether to operate the wiper, or whether to rotate the protective window according to an external environment or a driving situation, and may appropriately clean contamination of the LiDAR sensor in various situations.

The various embodiments of this disclosure and the terms used herein are not intended to limit the technical features described in this disclosure to specific embodiments, and should be understood to include various modifications, equivalents, or substitutes of the embodiments. In the description of the drawings, similar reference numerals may be used for similar or related components. A singular form of a noun corresponding to an item may include one or more of the item unless the context clearly dictates otherwise. In this disclosure, phrases such as “A or B,” “at least one of A and B,” “at least one of A or B,” “A, B, or C,” “at least one of A, B, and C,” and “at least one of A, B, or C” may each include any one of the listed items or any possible combinations of the listed items. Terms such as “first,” “second,” “primary,” or “secondary” may simply be used to distinguish one component from another corresponding component, and do not limit the components in other aspects (e.g., importance or order).When a component (e.g., a first component) is referred to as being “coupled” or “connected” to another component (e.g., a second component), with or without the terms “functionally” or “communicatively,” it may mean that the component may be directly connected (e.g., wired), wirelessly connected, or connected through a third component.

The term “module” used in this disclosure may include units implemented in hardware, software, or firmware, and may be used interchangeably with terms such as logic, logic blocks, components, or circuits. A module may be an integrated component, or may be a minimum unit or a portion of the component that performs one or more functions. For example, in an embodiment, a module may be implemented in a form of an application-specific integrated circuit (ASIC).

The various embodiments of this disclosure may be implemented as software (e.g., a program) including one or more instructions stored in a storage medium (e.g., an internal memory, an external memory, or the memory (240)) readable by a machine (e.g., a LiDAR cleaning system). For example, the processor of the device (e.g., the controller (250) of the LiDAR cleaning system (20)) may call at least one instruction among the one or more instructions stored in the storage medium and may execute the instruction. This may allow the device to operate so as to perform at least one function according to the called instruction. The one or more instructions may include code generated by a compiler or code executable by an interpreter. The machine-readable storage medium may be provided in a form of a non-transitory storage medium. Here, the term “non-transitory” merely indicates that the storage medium is a tangible device and does not include signals (e.g., electromagnetic waves). This term does not distinguish between data stored semi-permanently and data stored temporarily on the storage medium.

In an embodiment, a method according to the various embodiments disclosed in this disclosure may be provided as part of a computer program product. The computer program product may be traded as a commodity between a seller and a purchaser. The computer program product may be distributed in a form of a machine-readable storage medium (e.g., a compact disc read only memory (CD-ROM)), or may be distributed online through an application store (e.g., Play Store™) or directly between two user devices (e.g., smartphones) via downloading or uploading. In the case of online distribution, at least a portion of the computer program product may be temporarily stored or temporarily generated in a machine-readable storage medium such as a memory of a manufacturer’s server, an application-store server, or a relay server.

The components according to the various embodiments of this disclosure may be implemented in software or in hardware such as a digital signal processor (DSP), a field programmable gate array (FPGA), or an application specific integrated circuit (ASIC), and may perform predetermined roles. The term “components” is not limited to software or hardware, and each component may be configured to reside in an addressable storage medium or may be configured to execute one or more processors. For example, the components may include software components, object-oriented software components, class components, task components, processes, functions, attributes, procedures, subroutines, segments of program code, drivers, firmware, microcode, circuits, data, databases, data structures, tables, arrays, and variables.

In various embodiments, each of the above-described components (e.g., a module or a program) may include a single entity or multiple entities. In various embodiments, one or more of the above-described components or operations may be omitted, or one or more additional components or operations may be added. Alternatively or additionally, multiple components (e.g., modules or programs) may be integrated into a single component. In such a case, the integrated component may perform one or more functions of each of the plurality of components in the same or similar manner as performed by the corresponding components before integration. In various embodiments, operations performed by a module, program, or another component may be executed sequentially, in parallel, repetitively, or heuristically, and one or more of the operations may be executed in a different order, may be omitted, or one or more additional operations may be added.

What is claimed is:

1. A LiDAR cleaning system comprising:
a case including a transparent protective window and configured to protect a LiDAR sensor mounted therein;
a cleaning device configured to clean the protective window;
a communication module configured to obtain driving information of a vehicle; and
a controller functionally connected to the LiDAR sensor, the cleaning device, and the communication module,
wherein the controller is configured to:
determine whether the LiDAR sensor is obstructed due to contamination of the protective window using the LiDAR sensor; when obstruction of the LiDAR sensor is confirmed, determine whether a driving situation satisfies a safe operating condition of the cleaning device based on the driving information; and when the driving situation satisfies the operating condition, remove contamination of the protective window through the cleaning device.

2. The LiDAR cleaning system of claim 1, wherein the controller is configured to determine that the driving situation satisfies the operating condition when a driving speed corresponding to the driving information is lower than a threshold speed or when a lane-change situation is confirmed based on the driving information.

3. The LiDAR cleaning system of claim 1,
wherein the protective window is a rotatable cylindrical structure,
wherein the cleaning device includes a silicone blade of a wiper configured to contact a side surface of the protective window, and
wherein the controller is configured to rotate the protective window, with the silicone blade in contact therewith, to remove contamination of the protective window when the driving situation satisfies the operating condition.

4. The LiDAR cleaning system of claim 3,
wherein the cleaning device further includes a driving motor configured to move the wiper to contact the protective window or to be spaced apart from the protective window, and
wherein the controller is configured to cause the wiper to contact a side surface of the protective window through the driving motor when the driving situation satisfies the operating condition, and to place the wiper in a state spaced apart from the protective window through the driving motor after completion of cleaning.

5. The LiDAR cleaning system of claim 4, wherein the case includes:
a lower member fixed to an upper surface of the vehicle and configured to support a lower portion of the protective window so as to allow rotation of the protective window; and
a side groove of the lower member configured to fix one end of the wiper such that the one end is switchable between a first state and a second state.

6. The LiDAR cleaning system of claim 3,
wherein the controller is configured to, when the driving situation does not satisfy the operating condition,
determine a driving direction based on the driving information,
maintain the wiper of the cleaning device in a state spaced apart from the protective window, and
rotate the protective window such that a region of the contamination moves out of the driving direction.

7. The LiDAR cleaning system of claim 3,
wherein the cleaning device is configured to inject a cleaning liquid onto the protective window, and
wherein the controller is configured to adjust at least one of an amount of the cleaning liquid and a rotational speed of the protective window according to a driving speed confirmed based on the driving information.

8. The LiDAR cleaning system of claim 1,
wherein the controller is configured to determine at least one environmental condition from a weather condition or external temperature-humidity information of the vehicle through the communication module, and
to adjust a cleaning cycle and a cleaning intensity of the protective window through the cleaning device based on the at least one environmental condition.

9. The LiDAR cleaning system of claim 8,
wherein the controller is configured to remove contamination of the protective window through the cleaning device regardless of whether the operating condition is satisfied when the controller confirms, based on the at least one environmental condition, that the contamination of the protective window is higher than a threshold.

10. The LiDAR cleaning system of claim 8, further comprising a heating device,
wherein the controller is configured to operate the heating device to heat the protective window when the controller predicts icing based on the at least one environmental condition.

11. The LiDAR cleaning system of claim 1,
wherein the controller is configured to determine obstacle-region information detected through the LiDAR sensor and to remove contamination through the cleaning device such that obstacle detection of the LiDAR sensor is not hindered based on the obstacle-region information.

12. A method for cleaning a LiDAR sensor mounted in a case having a transparent protective window, the method comprising:
determining, using the LiDAR sensor, whether the LiDAR sensor is obstructed due to contamination of the protective window;
when obstruction of the LiDAR sensor is confirmed, determining whether a driving situation satisfies a safe operating condition of a cleaning device based on driving information of a vehicle; and
when the driving situation satisfies the operating condition, removing contamination of the protective window through the cleaning device.

13. The method of claim 12,
wherein the determining of whether the driving situation satisfies the operating condition includes determining that the driving situation satisfies the operating condition when a driving speed according to the driving information is lower than a threshold speed.

14. The method of claim 12,
wherein the removing contamination of the protective window includes determining a driving speed based on the driving information and adjusting a cleaning intensity of the cleaning device according to the driving speed.

15. The method of claim 12,
wherein the removing contamination of the protective window includes rotating a cylindrical protective window while a silicone blade of a wiper is in contact with a side surface of the protective window when the driving situation satisfies the operating condition, and removing contamination of the protective window through the silicone blade.

16. The method of claim 15,
wherein the removing includes moving the wiper, which is in a state spaced apart from the protective window, to contact the protective window with the silicone blade when the driving situation satisfies the operating condition, and further includes spacing the silicone blade of the wiper apart from the protective window when removal of contamination of the protective window is completed.

17. The method of claim 12, further comprising:
determining a driving direction based on the driving information when the driving situation does not satisfy the operating condition; and
rotating the protective window such that a contaminated region moves out of the driving direction without operating the wiper of the cleaning device.

18. The method of claim 12, comprising:
determining at least one environmental condition among temperature-humidity information detected through a vehicle sensor and a weather condition confirmed through external communication; and
adjusting a cleaning cycle and a cleaning intensity of the protective window through the cleaning device based on the at least one environmental condition.

19. The method of claim 18,
wherein the removing includes removing contamination of the protective window through the cleaning device regardless of whether the operating condition is satisfied when a degree of contamination of the protective window is higher than a threshold based on the at least one environmental condition.

20. A LiDAR cleaning system comprising:
a transparent protective window disposed to cover a LiDAR sensor so as to maintain a field of view of the LiDAR sensor;
a foldable wiper configured to selectively contact or be spaced apart from the protective window;
a first motor configured to move the wiper;
a second motor configured to rotate the protective window; and
a controller,
wherein the controller is configured to:
control the first motor to bring the wiper into contact with the protective window, and control the second motor to rotate the protective window while the wiper contacts the protective window to remove contamination from the protective window; or
control the first motor to space the wiper apart from the protective window, and control the second motor to rotate the protective window while the wiper is spaced apart from the protective window.
